(19) United States
(12) Patent Application Publication
(10) Pub. No.: US 2017/0326942 A1
(43) Pub. Date: Nov. 16, 2017

(54) SYSTEM AND METHOD FOR FLUSHING AND CLEANING AIR CONDITIONING SYSTEM

(71) Applicant: Yehoshua OHAYON, Netanya (IL)

(72) Inventor: Yehoshua OHAYON, Netanya (IL)

(21) Appl. No.: 15/527,510

(22) PCT Filed: Nov. 15, 2015
(86) PCT No.: PCT/IL2015/051099

§ 371 Date: May 17, 2017

Related U.S. Application Data
(60) Provisional application No. 62/080,424, filed on Nov. 17, 2014.

(51) Int. Cl. B60H 1/00; B08B 9/032

(52) U.S. Cl. CPC B60H 1/00585; B08B 9/0321

(57) ABSTRACT

The present invention provides systems for cleaning air conditioning systems, especially vehicle air conditioning systems, and methods utilizing said systems, wherein said cleaning systems comprise: a set of designated connectors; a cleaning fluid container; a heating element; a pump; and a filter.

### FIELD OF THE INVENTION

The present invention relates to the field of air conditioning systems. More particularly, the invention relates to a novel system and method for flushing and cleaning air conditioning systems. Even more particularly, the invention relates to a novel system and method for flushing and cleaning air conditioning systems of any transportation means, in a fast and cost efficient way. More particularly, said transportation means are vehicles.

### BACKGROUND OF THE INVENTION

Currently, when an automotive air conditioning system is serviced, several major components of the system are commonly replaced. For example, condenser coil (i.e., heat exchanger), evaporator coil, thermal expansion valve, liquid refrigerant metering orifice, receiver/drier (which is almost always replaced), and compressor.

In addition to the parts replacement, the lubricating oil must be drained from the air conditioning system, and new oil must be supplied into the system. Such lubricating compositions which are used in automotive air conditioning systems must not only clean and lubricate moving parts, but must also cycle repeatedly through an automotive air conditioning system, without breaking down under conditions of high temperatures and pressures. The lubricants must also be capable of flowing through the system at low temperatures.

Contamination is a known issue in air conditioning systems, such as due to malfunctioning of a compressor of a vehicle or other air conditioned machine, which causes burned and/or extra thick lubricant oil to attach to the air conditioning systems' components. Current day cleaning protocols force the replacing of many components in the air conditioning system, such as the condenser, dryer, compressor and evaporator, regardless if they are malfunctioned or not, and further requires flushing the system with special cleaning compositions sometimes in addition to the replacement of the different components. As a final step, the entire system has to be dried in order to verify no water residues remain therein, which might damage the system and/or reduce its effectiveness.

Such a process is time consuming and expensive. However, if the process is not performed completely, then the new compressor will soon malfunction, which will require repeating said process. Moreover, in order to avoid contaminating the system with water, special gas or solid in liquid-form, and especially non-water cleaning compositions are used. Often, organic-based cleaning compositions are used. Such compositions are often hazardous and combustible. Such compositions are also less efficient for cleaning purposes than fluid based detergents. Hence, an improved system and method for cleaning and fixing vehicle air conditioning systems as described in this application are still a long felt need. Other objects and advantages of the present invention will appear as description proceeds.

### SUMMARY OF THE INVENTION

In certain embodiments, the present invention provides an air conditioning cleaning system 107 comprising: (i) a set of connectors 102 enabling to connect said cleaning system 107 to an air conditioning system 101; (ii) a cleaning fluid container 103; (iii) a heating element 104 associated with said cleaning fluid container 103, thereby enabling heating said cleaning fluid within said cleaning fluid container 103; (iv) a pump 105; and (v) a filter or a filtration system 106, wherein said cleaning fluid container 103, said heating element 104, said pump 105 and said filter 106 are in fluid connection with one another, and wherein said cleaning fluid is a water-based cleaning fluid.

In another embodiment, the present invention provides a system 100 for cleaning air conditioning system 101, said system 100 comprises: an air conditioning system 101; and an air conditioning cleaning system 107 comprising: (i) a set of connectors 102 allowing to connect said air conditioning cleaning system 107 to said air conditioning system 101; (ii) a cleaning fluid container 103; (iii) a heating element 104 allowing heating said cleaning fluid inside said cleaning fluid container 103; (iv) a pump 105; and (v) a filter 106, wherein said cleaning fluid container 103, heating element 104, pump 105 and filter 106 are in fluid connection with one another and with said air conditioning system 101 via said set of connectors 102, and wherein said cleaning fluid is a water-based cleaning fluid.

In yet another embodiment, the present invention provides a method for cleaning an air conditioning system 101 comprising steps of: (i) providing the air conditioning cleaning system 107 according to any one of claims 1-12; (ii) connecting said air conditioning cleaning system 107 to said air conditioning system 101 using said set of connectors 102; (iii) preheating said cleaning fluid in said cleaning fluid container 103 using said heating element 104; (iv) allowing said pump 105 to push said heated cleaning fluid from said cleaning fluid container 103 to said air conditioning system 101 wherein said cleaning fluid is pushed in the opposite direction of the direction of the refrigerant flow within said air conditioning system 101; (v) circulating said cleaning fluid through said air conditioning system 101 and said air conditioning cleaning system 107, while filtering said cleaning fluid with said filter 106; (vi) optionally, reheating said cleaning fluid in said cleaning fluid container 103; (vii) draining said cleaning fluid from said air conditioning system 101; and (viii) allowing said air conditioning system 101 to dehydrate.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates the components of an embodiment of the present invention;

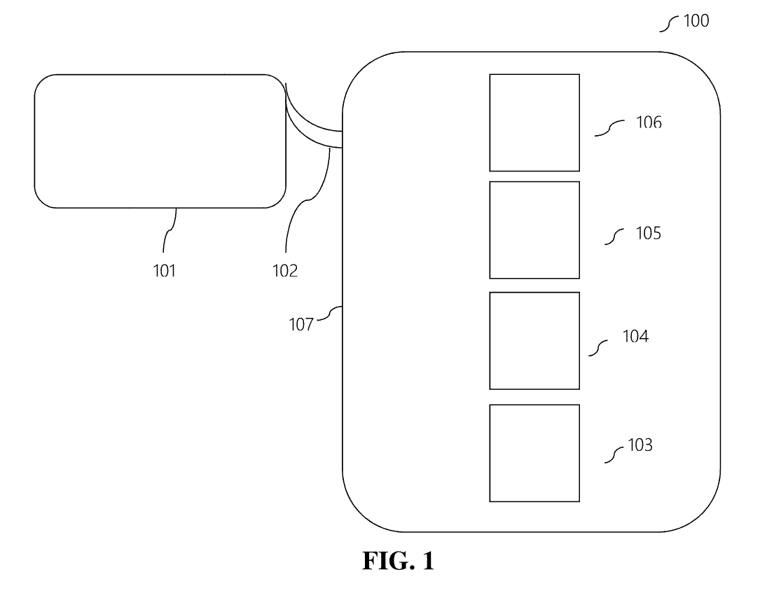

FIG. 2 illustrates a flow chart of a process according to an embodiment of the present invention; and

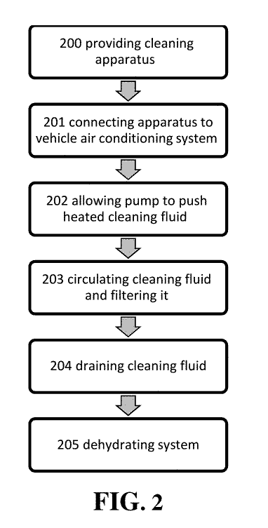

FIG. 3 illustrates a specific embodiment of the air conditioning system of the invention.

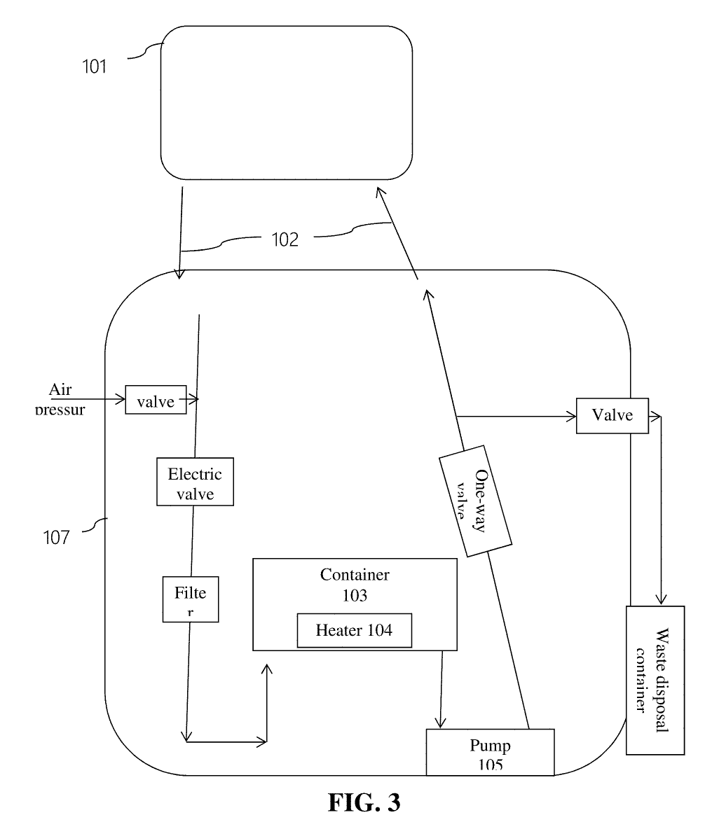

### DETAILED DESCRIPTION OF THE INVENTION

It has now been found that cleaning the inside of an air conditioning system, including all of its components, can be done in an easy, fast and effortless manner by using the air conditioning cleaning system 107 of the invention.

Accordingly, in an embodiment, the present invention provides an air conditioning cleaning system 107 comprising: (i) a set of connectors or adaptors 102 enabling to connect said cleaning system 107 to any air conditioning system 101 via any form and shape of connecting means or elements present in said air conditioning system 101; (ii) a cleaning fluid container 103; (iii) a heating element 104 associated with said cleaning fluid container 103, thereby enabling heating said cleaning fluid within said cleaning fluid container 103; (iv) a pump 105; and (v) a filter 106, wherein said cleaning fluid container 103, said heating element 104, said pump 105 and said filter 106 are in fluid connection with one another, and wherein said cleaning fluid is a water-based cleaning fluid.

As used herein the term “connector” means any device for joining two, or more, components together, by any suitable way such as screwing, clipping, etc. Such “connector” may be designed to connect two or more components having completely different connecting means, e.g. screwing of different size and shape.

In certain embodiments, the present invention further provides a system 100 for cleaning any air conditioning system 101, said system 100 comprises in one end an air conditioning system 101 and on the other end an air conditioning cleaning system 107 of the invention comprising: (i) a set of connectors 102 allowing to connect said air conditioning cleaning system 107 to said air conditioning system 101; (ii) a cleaning fluid container 103; (iii) a heating element 104 allowing heating said cleaning fluid inside said cleaning fluid container 103; (iv) a pump 105; and (v) a filter 106, wherein said cleaning fluid container 103, heating element 104, pump 105 and filter 106 are in fluid connection with one another and with said air conditioning system 101 via said set of connectors 102, and wherein said cleaning fluid is a water-based cleaning fluid.

The term “cleaning fluid” as used herein refers to any water-based fluid that is suitable for cleaning, i.e. water together with suitable cleaning agents. Said cleaning agents are substances (usually liquids, powders, sprays, or granules) that are being used to remove dirt, including dust, stains, and clutter on surfaces. In a specific embodiment, the cleaning agents used in the cleaning fluid of the present invention are a degreaser and/or a detergent.

In certain embodiments, the air conditioning cleaning system 107 of the invention further comprises a gas pressure unit, which enables to push or pump a gas into the air conditioning system 101 if and when needed, e.g. for drying said air conditioning system 101 and removal of water residues therein after the cleaning of the air conditioning system 101 is over and all the cleaning fluid is removed. In certain embodiments, said gas pressure unit comprises a gas compressor and gas dryer. It should be noted that the term “gas” as used herein refers to any suitable gas, such as air, nitrogen, or oxygen.

In certain embodiments, said set of connectors 102 in the air conditioning cleaning system 107 of the invention, is connected instead of the compressor of said air conditioning system 101, i.e. to the two pipes or tubes to which said compressor was attached before dismantling it for replacement. In a specific embodiment, said set of connectors 102 comprises universal connectors enabling the connection of any air conditioning cleaning system 107 to any air conditioning system 101.

The term “set of connectors” as used herein refers to a set comprising any number of connectors, such as 1, 2, 3, 4, 5, 6, 7, 8, 9, 10 or more.

In certain embodiments, the air conditioning cleaning system 107 of the invention further comprises at least one sensor, wherein said sensor allows said air conditioning cleaning system 107 to, e.g., sense that the air conditioning system 101 is flooded, i.e. that the cleaning fluid reached and spread throughout the entire inner space of said air conditioning system 101 and that no gas remains therein.

In certain embodiments, the air conditioning cleaning system 107 of the invention further comprises a thermostat, wherein said thermostat allows measuring the temperature of said cleaning fluid, and when it reaches a predefined temperature the air conditioning cleaning system 107 may stop the heating of the cleaning fluid and pump it into said air conditioning system 101. In certain embodiments, said predefined temperature does not exceed the water boiling temperature. In specific embodiments, said temperature is up to about 95° C. In another specific embodiment, said temperature is about 95° C., 90° C., 85° C., 80° C., 75° C., 70° C., 65° C., 60° C., 55° C., 50° C., 45° C., or 40° C. In another embodiment, said temperature is in the range of from about 40° C. to about 95° C., from about 40° C. to about 90° C., from about 40° C. to about 85° C., from about 40° C. to about 80° C., from about 40° C. to about 70° C., from about 45° C. to about 90° C., from about 50° C. to about 95° C., from about 55° C. to about 95° C., or from about 60° C. to about 90° C.

In certain embodiments, the air conditioning cleaning system 107 of the invention further comprises at least one one-way valve to prevent reverse flow of the cleaning fluid. Said at least one one-way valve may be located at any desired point along the system. In certain embodiments the air conditioning cleaning system 107 of the invention comprises 1, 2, 3, or more one-way valves.

In certain embodiments, the air conditioning cleaning system 107 of the invention further comprises at least one waste disposal container for collecting used cleaning fluid.

In certain embodiments, the air conditioning system 101 being cleaned by the air conditioning cleaning system 107 of the invention is a vehicle air conditioning system. In certain embodiments, the air conditioning system 101 being cleaned by the air conditioning cleaning system 107 of the invention is any transportation means, such as a train, a plain, and a boat.

In another embodiment, the present invention provides a method for cleaning an air conditioning system 101, e.g. an air conditioning system of a transportation means, said method comprises the steps of: (i) providing the air conditioning cleaning system 107 of the invention; (ii) connecting said air conditioning cleaning system 107 to said air conditioning system 101 using said set of connectors 102; (iii) preheating said cleaning fluid in said cleaning fluid container 103 using said heating element 104; (iv) allowing said pump 105 to push said heated cleaning fluid from said cleaning fluid container 103 to said air conditioning system 101, wherein said cleaning fluid is pushed in the opposite direction of the direction of the refrigerant flow within said air conditioning system 101; (v) circulating said cleaning fluid through said air conditioning system 101 and said air conditioning cleaning system 107, while filtering said cleaning fluid with said filter 106; (vi) optionally, reheating said cleaning fluid in said cleaning fluid container 103; (vii) draining said cleaning fluid from said air conditioning system 101; and (viii) allowing said air conditioning system 101 to dehydrate.

In certain embodiments, once the air conditioning system 101 is flooded, the air conditioning cleaning system 107 begins circulating the cleaning fluid through the system 100 and into/through said filter or filtration system 106. The circulation process, duration and speed may be predefined or controlled in real time. The circulation process may be stopped or paused for, e.g., checking the cleaning fluid to evaluate if further circulation is required, if it is required to change/replace the cleaning fluid, etc.

In certain embodiments, once the circulation process ends, the air conditioning system 101 is drained from said cleaning fluid, and is left for dehydration. In an embodiment of the invention, the dehydration process includes pushing or pumping pressurized and/or dried air, or any other suitable gas, into and through the air conditioning system 101 in order to allow vapors and steam of said cleaning fluids to exit the air conditioning system 101. Finally, after said air conditioning system 101 is dried, the new or refurbished compressor is connected to the air conditioning system 101, followed by refilling or charging with new refrigerant.

In certain embodiments, said optional reheating said cleaning fluid step is carried out either while the cleaning fluid flows through said cleaning fluid container 103, or by stopping the flow, reheating the cleaning fluid residing within said cleaning fluid container 103 and then continue the flow once the cleaning fluid reaches the desired temperature.

In certain embodiments, the cleaning method of the invention enables washing and cleaning the inside of the entire air conditioning system 101 and all of its components simultaneously, without the need to dismantle each component therein.

In certain embodiments, step in the cleaning method of the invention is carried out by pumping or pushing dry gas into said air conditioning system 101 in the same direction as the direction of the refrigerant flow within said air conditioning system 101.

In certain embodiments, the cleaning method of the invention further comprises a step of disassembling the compressor of the air conditioning system 101 prior to the connecting of said air conditioning cleaning system 107 to said air conditioning system 101 via the pipes or tubes to which said compressor was attached.

In certain embodiments, the cleaning method of the invention further comprises post-cleaning steps of reassembling a new or refurbished compressor to the air conditioning system 101, replacing the dryer, creating a vacuum within said air conditioning system 101, and charging said air conditioning system 101 with a suitable refrigerant.

In a specific embodiment, the step of creating vacuum within said air conditioning system 101 enables and/or improves and/or shortens the duration of evaporation of cleaning fluid residues remaining therewithin.

In certain embodiments, said set of connectors 102 is connected to the tubes or pipes to which the compressor of said air conditioning system 101 was connected.

In certain embodiments, the cleaning fluid used in the cleaning method of the invention comprises water and detergent. In a specific embodiment, said cleaning fluid further comprises defoamer. In yet another specific embodiment, said cleaning fluid further comprises water-based degreaser.

In certain embodiments, the preheating in step (iii) and the reheating in step (vi) brings the temperature of the cleaning fluid up to about 95° C. In a specific embodiment, said temperature is in the range of from about 40° C. to about 95° C., from about 40° C. to about 90° C., from about 40° C. to about 85° C., from about 40° C. to about 80° C., from about 40° C. to about 70° C., from about 45° C. to about 90° C., from about 50° C. to about 95° C., from about 55° C. to about 95° C., or from about 60° C. to about 90° C.

In certain embodiments, the cleaning method of the invention further comprises a step of sensing when said air conditioning system 101 is flooded, i.e. completely filled with said cleaning fluid.

In a specific embodiment, the air conditioning system 101 being cleaned by the air conditioning cleaning system 107 of the invention is a vehicle air conditioning system.

According to an aspect of the present invention a vehicle air conditioning cleaning system comprising: at least one set of connectors 102 wherein said connectors allow connecting the a cleaning apparatus according to the invention to at least one vehicle air conditioning system; at least one cleaning fluid container 103; at least one heating element 104 wherein said heating element 104 allows heating said cleaning fluid; at least one pump 105; and at least one filter 106, wherein said at least one cleaning fluid container 103, at least one heating element 104, at least one pump 105 and at least one filter 106 are in fluid connection with said at least one vehicle air conditioning system via said at least one set of connectors 102.

It is further within provision of the invention to have system, wherein said at least one set of connectors 102 is connected instead of said air conditioning system's compressor.

It is further within provision of the invention to have system, wherein said at least one set of connectors 102 comprise universal connectors.

It is further within provision of the invention to further comprising at least one sensor, wherein said sensor allows said cleaning apparatus to sense that the air conditioning system 101 is flooded.

Another aspect of the present invention provides a method for vehicle air conditioning cleaning comprising the steps of: providing at least one cleaning apparatus 107 according to the invention comprising: at least one set of connectors 102; at least one cleaning fluid container 103; at least one heating element 104; at least one pump 105; and at least one filter 106; connecting said cleaning apparatus 107 to at least one vehicle air conditioning system 101 using said at least one set of connectors 102; allowing said pump 105 to push cleaning fluid from said cleaning fluid container 103 to said at least one vehicle air conditioning system 101 wherein said cleaning fluid was preheated to a predefined temperature using said at least one heating element 104 and wherein said cleaning fluid is pushed against the air conditioning system's refrigerant flow direction; allowing said pump 105, while the system is flooded, to circulate said cleaning fluid wherein said cleaning fluid is being filtered by said at least one filter 106; draining said cleaning fluid from said air conditioning system 101; and allowing said air conditioning system 101 to dehydrate.

It is further within provision of the invention to further comprise the method wherein said cleaning fluid comprises detergent, defoamer, vinegar, water and water based degreaser.

It is further within provision of the invention to further comprise the method wherein said predetermined temperature is up to 90° C.

It is further within provision of the invention to further comprise steps of: allowing said air conditioning system 101 to reach a temperature of more than water boiling temperature using vacuum and allowing said air conditioning system 101 to dehydrate by allowing steam to escape. It is further within provision of the invention to further comprise steps prior to the charging of new refrigerant into the cleaned air conditioning system 101, said steps include creating a vacuum in said air conditioning system 101 optionally accompanying by heating said air conditioning system 101, optionally by turning the vehicle on.

It is further within provision of the invention to further comprise steps of: creating vacuum within said air conditioning system while said system's temperature allow evaporation of said cleaning fluid residues.

These, additional, and/or other aspects and/or advantages of the present invention are set forth in the detailed description which follows; possibly inferable from the detailed description; and/or learnable by practice of the present invention.

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for flushing air conditioning system of vehicles.

In the above and following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The invention relates to systems and methods for flushing various air conditioning systems, e.g., of vehicles, without the replacement of multiple parts other than the compressor.

Generally speaking, the system and method may allow the connection of an external device, in most cases by a professional such as a mechanic, e.g. car mechanic, to the air conditioning system 101 and perform a process that will flush and clean said air conditioning system 101. In some embodiments of the invention, the system may be operated even by a layman.

The system comprises a cleaning apparatus or system 107 designed to connect to the air conditioning system 101 of a vehicle. Such connection may be performed by universal or dedicated connectors 102 designed to connect the apparatus 107 instead of the compressor.

In an embodiment of the invention, the system 100 may comprise several key elements: one or more sets of connectors 102 that may allow connecting the system's cleaning apparatus 107 to at least one vehicle air conditioning system 101.

In some embodiments of the invention, such a connection may be achieved by removing or separating the malfunctioning compressor from the rest of the air conditioning system 101 and connecting the cleaning apparatus 107 instead. In further embodiments of the invention, such connectors 102 may be universal connectors and hence allow connecting the cleaning apparatus 107 to most or all air conditioning systems 101.

The apparatus may further comprise fluid container or containers 103 in which the cleaning fluid is stored prior to, and in some embodiments also during, the activation of the cleaning apparatus 107.

In addition, the apparatus may further comprise a heating element 104. The heating element 104 may further comprise a thermostat and heat sensors as known in the art. The heating element 104 may heat the cleaning fluid, in some embodiments such heating will occur when the fluid is in its container 103 while in other embodiments the heating may occur elsewhere such as during the passing of the fluid in pipes or in a special heating chamber.

The invention may further comprise pump or pumps 105 that may allow the pushing of the fluid in the system 100 as well as a filter or filtration subsystem 106 that will allow filtration of the cleaning fluid once it comes out of the air conditioning system 101.

As it may be understood, the elements of the cleaning apparatus 107 are in fluid connection with one another and with the air conditioning system 101.

In some embodiments of the invention the cleaning apparatus 107 may further comprise sensor or sensors that will allow the apparatus to sense when the air conditioning system 101 is flooded with the cleaning fluid. In one embodiment of the invention such sensing may allow the system 100 to start a circulation process which may be different from the flooding process.

A cleaning method for vehicle air conditioning cleaning may comprise several steps. First, providing the cleaning apparatus 201 and connecting 202 the apparatus to a vehicle's air conditioning system 101 using a set of connectors 102.

Then, allowing the pump 105 to push cleaning fluid 203 from the cleaning fluid container 103 to the, e.g., vehicle air conditioning system 101. The cleaning fluid will be preheated to a predefined temperature using the heating element 104 prior to it being pushed into the air conditioning system 101. In one embodiment of the invention the temperature may be set using the apparatus' controls. In some embodiments of the invention, the temperature would be up to 90° C.

The fluid may be pushed to the air conditioning system 101 against the system's refrigerant flow direction.

As may be understood, the initial pushing may allow the flooding of the system with the cleaning fluid. In some embodiments of the invention, a sensor may instruct the cleaning apparatus 107 that the air conditioning system 101 is flooded and may allow initiating the circulation process.

Once the system 101 is flooded, the apparatus 107 may circulate the cleaning fluid through the system and into a filter or filtration subsystem 106 in the apparatus. The circulation process may be predefined or controlled in real time. The process may be stopped or paused for the purpose of checking the cleaning fluid to evaluate if further circulation is required, if change of cleaning fluid is required etc.

Once the circulation process ended the system 101 may be drained 204 from the cleaning fluid and the system may be left for dehydration 205.

In an embodiment of the invention, the dehydration process includes pushing pressurized air (or dried air) through the system in order to allow vapors and steam to exit the system. In other embodiments of the invention, the system may allow pushing nitrogen or any other gas besides air through the system.

In some embodiments of the invention, for better dehydration process the system will be allowed to reach a temperature higher than water boiling temperature. In other embodiments of the invention, the system will then be disconnected from the apparatus and may be left opened to allow steam to escape. In other embodiments of the invention, the system will be allowed to reach a temperature lower than the water boiling temperature but high enough to allow faster dehydration of any water residue in the system.

In other embodiments of the invention, a vacuum will be created in the system 101 while the system's temperature may allow vacuum evaporation of the fluid's residue.

In one embodiment of the invention the cleaning fluid comprises detergent, defoamer, vinegar, water and water based degreaser.

Although selected embodiments of the present invention have been shown and described, it is to be understood that the present invention is not limited to the described embodiments. Instead, it is to be appreciated that changes may be made to these embodiments without departing from the principles and spirit of the invention, the scope of which is defined by the claims and the equivalents thereof.

1. An air conditioning cleaning system comprising:
a set of connectors enabling to connect said cleaning system to an air conditioning system
a water based cleaning fluid container;
a heating element associated with said cleaning fluid container, thereby enabling heating said cleaning fluid within said cleaning fluid container;
a pump; and
a filter,
wherein said cleaning fluid container, said heating element, said pump and said filter are in fluid connection with one another.

2. A system for cleaning air conditioning system, said system comprises:
an air conditioning system; and
an air conditioning cleaning system according to claim 1,
wherein said cleaning fluid container, heating element, pump and filter are in fluid connection with one another and with said air conditioning system via said set of connectors.

3. (canceled)

4. The air conditioning cleaning system of claim 1, further comprising a gas pressure unit, which optionally comprises a gas compressor and gas dryer.

5. (canceled)

6. The air conditioning cleaning system of claim 1, wherein said set of connectors is connected instead of said air conditioning system's compressor.

7. The air conditioning cleaning system of claim 6, wherein said set of connectors comprises universal connectors.

8. The air conditioning cleaning system of claim 1, further comprising at least one sensor, wherein said sensor allows said air conditioning cleaning system to sense that the air conditioning system is flooded.

9. The air conditioning cleaning system of claim 1, further comprising a thermostat, wherein said thermostat allows pumping said cleaning fluid into said air conditioning system only when said cleaning fluid reaches a predefined temperature, which ranges from 40° C. to 95° C.

10. (canceled)

11. The air conditioning cleaning system of claim 1, further comprising at least one one-way valve and/or at least one waste disposal container.

12. (canceled)

13. The air conditioning cleaning system of claim 1, wherein said air conditioning system is a vehicle air conditioning system.

14. A method for cleaning an air conditioning system comprising the steps of:
(i) providing the air conditioning cleaning system according to claim 1;
(ii) connecting said air conditioning cleaning system to said air conditioning system using said set of connectors;
(iii) preheating said cleaning fluid in said cleaning fluid container using said heating element;
(iv) allowing said pump to push said heated cleaning fluid from said cleaning fluid container to said air conditioning system wherein said cleaning fluid is pushed in the opposite direction of the direction of the refrigerant flow within said air conditioning system;
(v) circulating said cleaning fluid through said air conditioning system and said air conditioning cleaning system, while filtering said cleaning fluid with said filter;
(vi) optionally, reheating said cleaning fluid in said cleaning fluid container;
(vii) draining said cleaning fluid from said air conditioning system; and
(viii) allowing said air conditioning system to dehydrate,
wherein said method enables washing and cleaning the entire air conditioning system and all of its components simultaneously, without the need to dismantle each component therein.

15. (canceled)

16. The method of claim 14, wherein said dehydration is carried out by pumping dry gas into said air conditioning system in the same direction as the direction of the refrigerant flow within said air conditioning system.

17. The method of claim 14, further comprising a step of:
disassembling the compressor of the air conditioning system prior to the connecting of said air conditioning cleaning system to said air conditioning system;
reassembling a new compressor;
replacing the dryer; creating a vacuum within said air conditioning system; and
charging said air conditioning system with a suitable refrigerant.

18. (canceled)

19. The method of claim 14, wherein the creation of the vacuum within said air conditioning system enables evaporation of cleaning fluid residue.

20. The method of claim 14, wherein said set of connectors is connected to the tubes to which the compressor of said air conditioning system was connected.

21. The method of claim 14, wherein said cleaning fluid comprises water and detergent and optionally a defoamer and/or a water-based degreaser.

22-23. (canceled)

24. The method of claim 14, wherein said predetermined temperature is about 95° C. or less.

25. The method of claim 14, further comprising a step of sensing when said air conditioning system is flooded.

26. The method of claim 14, wherein said air conditioning system is a vehicle air conditioning system.
